(19) United States
(12) Patent Application Publication
(10) Pub. No.: US 2017/0254828 A1
(43) Pub. Date: Sep. 7, 2017

(54) FLOW ANGLE PROBE

(71) Applicant: GENERAL ELECTRIC COMPANY, Schenectady, NY (US)

(72) Inventors: Andreas Herrig, Munich (DE); Carsten Michael Schneider, Munich (DE); Erik Mele, Haslum (NO); Siddharth Navinchandra Ashar, Clifton Park, NY (US)

(21) Appl. No.: 15/075,941

(22) Filed: Mar. 21, 2016

Related U.S. Application Data
(60) Provisional application No. 62/302,246, filed on Mar. 2, 2016.

(51) Int. Cl. G01P 13/00

(52) U.S. Cl. CPC G01P 13/0006; G01P 13/0053

(57) ABSTRACT

A flow angle probe is provided having (a) a probe flap for contacting a moving fluid within a fluid conduit; (b) a probe body mechanically coupled to the probe flap; (c) a force sensor disposed within the probe body and operationally coupled to the probe flap; and optionally (d) a probe shaft coupled to the probe body. A deflection of the probe flap caused by contact with the moving fluid produces a corresponding force sensor signal output which is minimized by rotation of the probe flap. The angle between this point of minimum deflection and a reference position is taken to be the flow angle of the moving fluid in the vicinity of the probe flap. The novel flow angle probes disclosed herein may be used in a wide variety of turbomachines and fluid processing systems, and applications, including turbomachine design and operational control, and in flow assurance.

### CROSS REFERENCE TO RELATED APPLICATIONS

The present application claims priority to U.S. provisional application No. 62/302,246 filed Mar. 2, 2016 and which is incorporated by reference herein in its entirety.

### BACKGROUND

The present invention relates to devices useful for measuring characteristics of a fluid flowing within a conduit. In particular, the present invention provides novel flow angle probes and systems containing them. Such flow angle probes may be used to detect the flow angle characteristics of a fluid flowing within a conduit.

Understanding the flow angle characteristics of a fluid moving within a fluid conduit of fluid processing equipment such as pumps and compressors can be used to optimize both equipment design and performance. While flow angles may be estimated for various equipment systems using computational fluid dynamics tools, real-time monitoring of fluid flow angles within fluid processing equipment can be challenging, especially when the fluid in question is a multiphase fluid. While flow angle measurement devices and systems are known for use in measuring the flow angle characteristics of single phase fluids, devices and systems capable of reliably measuring flow angle characteristics of multiphase fluids are currently unknown. Thus, there exists a need for new devices and systems capable of such measurements in multiphase fluids.

### BRIEF DESCRIPTION

In one embodiment, the present invention provides a flow angle probe comprising: (a) a probe flap configured to contact a moving fluid within a fluid conduit; (b) a probe body mechanically coupled to the probe flap; (c) a force sensor disposed within the probe body and operationally coupled to the probe flap; and optionally (d) a probe shaft coupled to the probe body; wherein a deflection of the probe flap caused by contact with the moving fluid produces a corresponding sensed force in the force sensor; and wherein the sensed force produced in the force sensor may be minimized by rotation of the probe flap to a position in which deflection of the probe flap by the moving fluid is minimized.

In an alternate embodiment, the present invention provides a system comprising: (a) a fluid conduit configured to accommodate fluid flow; (b) a flow angle probe comprising: (i) a probe flap configured to contact a moving fluid within a fluid conduit; (ii) a probe body mechanically coupled to the probe flap; (iii) a force sensor disposed within the probe body and operationally coupled to the probe flap; and optionally (iv) a probe shaft coupled to the probe body; (d) a rotary driver configured to cause one or more of the probe body and the probe shaft to rotate; and (e) a controller configured to control the rotary driver; wherein a deflection of the probe flap caused by contact with the moving fluid produces a corresponding sensed force in the force sensor; and wherein the sensed force produced in the force sensor may be minimized by rotation of the probe flap to a position in which deflection of the probe flap by the moving fluid is minimized.

In yet another embodiment, the present invention provides a flow angle probe comprising: (a) a probe flap configured to contact a moving fluid within a fluid conduit; (b) a probe body mechanically coupled to the probe flap; (c) at least one strain sensor disposed within the probe body and operationally coupled to the probe flap; and (d) a probe shaft coupled to the probe body; wherein a deflection of the probe flap caused by contact with the moving fluid produces a corresponding strain in the strain sensor; and wherein the strain produced in the strain sensor may be minimized by rotation of the probe flap to a position in which deflection of the probe flap by the moving fluid is minimized.

### BRIEF DESCRIPTION OF THE DRAWING FIGURES

Various features, aspects, and advantages of the present invention will become better understood when the following detailed description is read with reference to the accompanying drawings in which like characters may represent like parts throughout the drawings. Unless otherwise indicated, the drawings provided herein are meant to illustrate key inventive features of the invention. These key inventive features are believed to be applicable in a wide variety of systems which comprising one or more embodiments of the invention. As such, the drawings are not meant to include all conventional features known by those of ordinary skill in the art to be required for the practice of the invention.

FIG. 1 illustrates a flow angle probe provided by the present invention.

FIG. 2 illustrates a flow angle probe provided by the present invention.

FIG. 3 illustrates a flow angle probe provided by the present invention.

FIG. 4 illustrates a system comprising a flow angle probe provided by the present invention.

FIG. 5 illustrates a system comprising a flow angle probe provided by the present invention

FIG. 6 illustrates a flow angle probe provided by the present invention.

FIG. 7 illustrates a flow angle probe provided by the present invention.

FIG. 8 illustrates a system comprising a flow angle probe provided by the present invention.

FIG. 9 illustrates a system comprising a flow angle probe provided by the present invention.

FIG. 10 illustrates components of a flow angle probe provided by the present invention.

FIG. 11 illustrates components of a flow angle probe provided by the present invention.

FIG. 12 illustrates a system provided by the present invention.

FIG. 13 illustrates a system provided by the present invention.

### DETAILED DESCRIPTION

In the following specification and the embodiments, which follow, reference will be made to a number of terms, which shall be defined to have the following meanings.

The singular forms “a”, “an”, and “the” include plural referents unless the context clearly dictates otherwise.

“Optional” or “optionally” means that the subsequently described event or circumstance may or may not occur, and that the description includes instances where the event occurs and instances where it does not.

Approximating language, as used herein throughout the specification and embodiments, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and embodiments, range limitations may be combined and/or interchanged, such ranges are identified and include all the sub-ranges contained therein unless context or language indicates otherwise.

As noted, in one or more embodiments, the present invention provides a flow angle probe for measuring the flow angle of a fluid flowing within a fluid conduit. The flow angle probe may be positioned within a fluid conduit such that at least a portion of a probe flap mechanically coupled to a probe body is configured to contact a moving fluid within the fluid conduit. As the text and figures of this disclosure will make clear, the expression “is configured to” means that a component or grouping of components is configured to do a certain thing, when it is capable of doing that particular thing. Logically then, one or more elements of a flow angle probe provided by the present invention are said to be configured to do a given thing when the recited element or elements are positioned in space to achieve the stated end. In various embodiments, the probe flap is deflected in response to contact with a fluid flowing within the conduit and one or more force sensors operationally coupled to the probe flap detect the deflection of the probe flap. The force sensors are typically strain sensors but may in some embodiments be stress sensors. Force sensors which may be advantageously employed according to one or more embodiments of the present invention include conventional metal-film strain gauges (SGs) bonded on the probe flap or piezo-resistive semi-conductor SGs, which can be directly embedded in a silicon probe flap structure or bonded on a metal probe flap, fiber-optic strain gauges such as fiber Bragg gratings or Fabry-Pérot type interferometer probes and fiber-optic stress sensors. Strain sensors can be used to measure stress as well, when the stress-strain relation is estimated from the material characteristics and geometric properties of the probe flap are taken into account, correcting for the adhesive and SG thickness, for example.

The flow angle at the probe location is determined as follows. Under non-turbulent flow conditions, the moving fluid is characterized by a flow angle in the vicinity of the flow angle probe's probe flap. The probe flap is fixed at one end within the probe body and typically does not rotate independently of the probe body. A portion of the probe flap extends from within the probe body and into the moving fluid within the fluid conduit. This arrangement uses the probe body as a shield which protects the force sensors attached to the probe flap from abrasion by the fluid flowing through the fluid conduit. The force of the moving fluid acting on the exposed portion of the probe flap causes a deflection of the probe flap by a certain amount in response, and the probe flap remains in that deflected state under the non-turbulent flow conditions. The flow angle may be determined by rotating the probe flap and monitoring the output signal of the force sensors during such rotation. When the output signal is at a minimum the flow angle of the moving fluid is represented by the angle between the probe flap in this minimum signal output position and a reference plane or axis of the fluid conduit. Expressed in a slightly different way, the probe is rotated to an angular position at which the signal output from the probe sensors corresponds to the force-free/no-load output determined without flow, and this angular position corresponds to the flow angle of the moving fluid in the vicinity of the probe flap. The flow angle is conveniently considered a local direction of fluid flow and this direction is defined as the angle between the reference plane or axis of the fluid and the reference direction of the probe.

In practice, the reference direction of the probe, at which it does not show a mean deviation of the output from the no-load condition, may be determined in a calibration conduit having known flow direction characteristics. In this way the impact of flow perturbation caused by the flow angle probe structure (probe flap, probe body and probe shaft) can be minimized. In some instances the reference direction may be determined geometrically via the chord of the plate can be sufficient.

The reference direction of the probe, at which it does not show a mean deviation of the output from the no-load condition, should be determined in a calibration facility with known flow direction before, to minimize the impact of small geometric deviations of flap and probe body.

If the required angle accuracy is lower, a geometric determination of the reference direction via the chord of the plate can be sufficient. Various means of rotating the probe flap may be used. For example, the probe flap may be rotated by rotating the probe body and optionally the probe shaft by any means in which the flow angle may be reliably determined, such means including geared stepper motor drives, servo systems comprising one or more encoders or potentiometers, toothed wheels and the like. Such means of rotating the probe flap are at times herein referred to as rotary drivers.

Under turbulent flow conditions the flow angle may vary at a rate faster than the flow angle probe can respond. Under such circumstances, the flow angle is essentially an instantaneous quantity, varying significantly over time and space within the fluid conduit. Thus, under certain turbulent flow conditions the flow angle probe provided by the present invention provides an approximated value of the flow angle in the vicinity of the probe flap. Such approximated values of flow angle may be reliably measured using the flow angle probes disclosed herein and may be used to form a moving average (or other statistical quantity) and to determine the mean flow angle and other flow characteristics with useful precision. Under weakly turbulent flow conditions the flow angle probe may provide a mean flow angle.

In one or more embodiments, the deflection of the probe flap is communicated to a force signal transceiver configured to receive the output of one or more force sensors linked to the probe flap and to transmit the force sensor signal to a processor/controller. The processor/controller may compile force sensor signal data and may control the position of the probe flap by causing one or more of the probe body and the probe shaft to rotate and determine the flow angle at the probe flap thereby. The flow angle data so produced can be used, for example, to map flow angles of a fluid at various locations within the fluid conduit. As will be appreciated by those of ordinary skill in the art, such flow angle mapping may be useful in the design and/or operational control of fluid processing equipment such as pumps, steam turbines, gas turbines, compressors, and like equipment. Alternatively, the data provided by the flow angle probe may be used in flow quality assurance applications, for example swirl detection upstream of swirl-sensitive measurement devices. In addition, the flow angle probe provided by the present invention may be used to detect flow disturbances occurring within a fluid conduit during production operations, for example detecting gas slugs in a multiphase production fluid being extracted from a hydrocarbon reservoir.

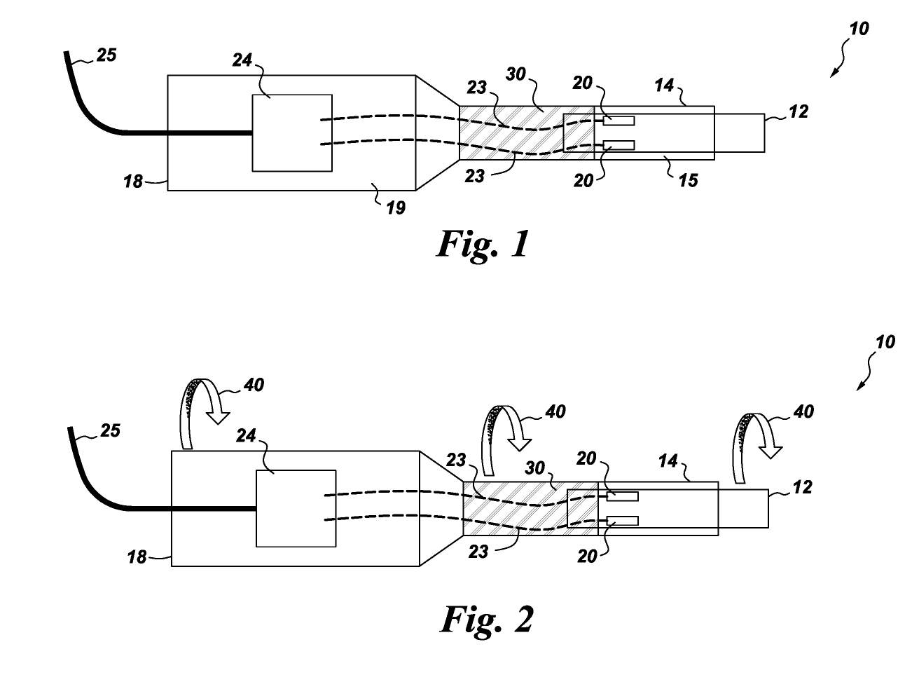

In one or more embodiments, the flow angle probe has as constituent parts (a) a probe flap configured to contact a moving fluid within a fluid conduit; (b) a probe body mechanically coupled to the probe flap and enveloping at least a portion of the probe flap; (c) a force sensor disposed within the probe body and operationally coupled to the probe flap; and optionally (d) a probe shaft coupled to the probe body. Such a flow angle probe 10 is illustrated by FIG. 1 in which a probe flap 12 is fixed at one end within a probe body 14. The probe flap is typically a flat, rectangular or wedge or airfoil shaped metal strip, which is sufficiently supple to undergo deflection when in contact with a moving fluid at a non-zero flow angle. The probe flap must be sufficiently stiff, however, to avoid facile contact with the probe body under the flow conditions to be investigated. While thin metal flaps are frequently preferred, flaps made from polymeric materials such as polyolefins such as polyethylene, polyesters such as polyethylene terephthalate, and polyethers such as PEEK may be used as well. In one or more embodiments, the probe flap comprises a fiber reinforced organic polymer, such as a carbon fiber reinforced organic polymer. In the embodiment shown, the probe body 14 is in turn mechanically coupled to a probe shaft 18. At least a portion of the probe flap extends from within the probe body and during operation this exposed portion of the probe flap is directly contacted by a moving fluid within a fluid conduit unimpeded by the walls of the probe body. At its opposite end, the probe flap is fixed within the probe body. In one or more embodiments, the probe flap may be fixed to the probe body in a cantilevered fashion using means known to those of ordinary skill in the art. In the embodiment shown, the probe flap is fixed within a flap fixative 30 such as a cured epoxy resin or an inorganic cement. Alternatively, the probe flap may be inserted into a slot or series of slots formed within the probe body interior 15. It should be noted that the interior 15 of the probe body 14 may be in fluid communication with interior of the fluid conduit. The probe flap 12 is positioned within interior 15 of the probe body such that in an undeflected state, and in a useful range of deflected states, the probe flap does not contact the interior walls of the probe body. In one or more embodiments, the probe flap 12 may be advantageously aligned within the probe body such that two of the four longest surfaces of the flap are effectively equidistant from the closest interior surface of a probe body having a cylindrical shape. In the embodiment shown, force sensors 20 are mounted on the surface of the probe flap 12 adjacent to its fixed end, however not within flap fixative 30, and are in fluid communication with the interior of the fluid conduit. Sensor link 23 connects the force sensors 20 to the force signal transceiver 24 located within the interior 19 of probe shaft 18 and are at times herein referred to as links to the force signal transceiver. Suitable sensor links 23 include electrically conductive wires such as are used in strain sensors, fiber optic cables, and magnetic and optical probes. Communications link 25 allows communication between the force signal transceiver 24 and other system components which may include equipment controllers and data processors.

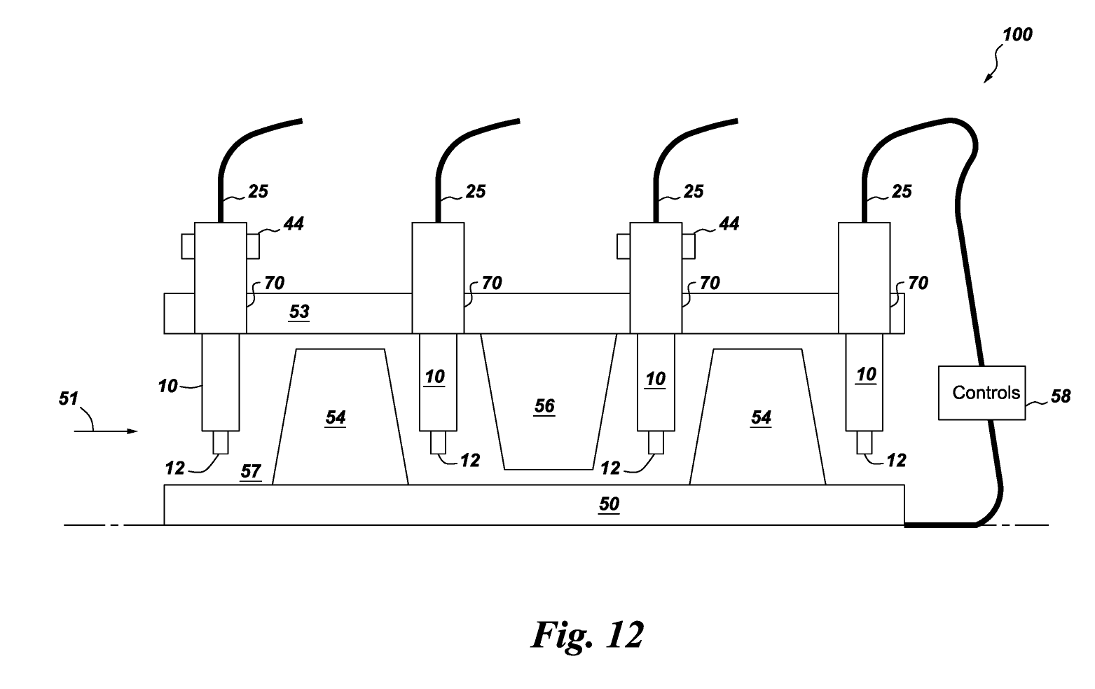

Still referring to FIG. 1, during operation the flow angle probe is mounted such that at least a portion of the probe flap 12 and probe body 14 will be in fluid contact with the interior of the fluid conduit through which a fluid is to flow. In one or more embodiments, the flow angle probe is disposed within an opening in a wall of the fluid conduit at times herein referred to as a transverse probe port 70 (see FIG. 12), the opening being adapted such that the flow angle probe fits securely and hermetically within the opening, and such that the probe flap 12 and at least a portion of the probe body 14 are disposed within the flow channel defined by the fluid conduit. In one or more embodiments, at least a portion of the flow angle probe is disposed outside of the flow channel defined by the fluid conduit. Alternately, the entire flow angle probe may be mounted within the flow channel of the fluid conduit. Under such circumstances, the flow angle probe may be linked to a processor located outside of the fluid conduit via a communications link configured to hermetically traverse a wall of the fluid conduit. Once the flow angle probe is in position, a fluid may be caused to flow within the fluid conduit and into contact with the probe flap which in turn deflects in response to contact with the movement of the fluid in the fluid conduit. The flow angle of the fluid in the vicinity of the probe flap is determined by rotation of the probe flap such that the output of one or more force sensors attached to the probe flap is minimized. The angle defined by the probe flap in this minimum signal output position and a reference plane (or axis) of the fluid conduit corresponds to the flow angle of the moving fluid at the probe flap. Typically, rotation angles of the probe flap are such that control and communications cables/links within the probe body and optionally the probe shaft and communications cable/links disposed outside of the probe body and probe shaft can be made sufficiently long to tolerate the torsion associated with the probe's rotation. Rotary contacts linking a rotating communications link to a stationary communications link may also be employed, but may present obstacles to the transmission of analog signals. However where the force signal transceiver is located within the rotating component of the flow angle probe, the use of such rotary contacts may be preferred, as for example in embodiments wherein a stationary communications link comprising one or more RJ45 cables receives one or more digital signals from a rotating force signal transceiver comprising an analog to digital converter. In one or more embodiments, the rotary contacts employ contactless slip rings to transmit both power and data between stationary and rotary components. A variety of such contactless electrical connectors are known in the art, such as those provided commercially by PowerbyProxi, Inc. of Auckland, New Zealand; among others.

As noted, at least a portion of the interior cavity of the probe body of the flow angle probe is in fluid communication with the environment surrounding the exposed portion of the probe flap. This arrangement simplifies probe construction, enhances the probe force sensor performance and provides for greater dynamic range of the probe. As a result, the flow angle probe provided by the present invention may be used to accurately record flow angles under both relatively high and relatively low dynamic pressure conditions. In one or more embodiments, it may be useful to protect a force signal transceiver 24 disposed within a probe shaft coupled the probe body from the environment surrounding the probe flap at its exposed end, for example when the force signal transceiver comprises a sensitive component susceptible to corrosion or fouling, and the environment of the probe flap induces corrosion and/or fouling. Under such circumstances, it is useful to shield the interior 19 of probe shaft 18 from the environment of the probe flap by creation of a hermetic seal between the interior 15 of the probe body 14 and the interior 19 of the probe shaft 18. Any suitable sealant known in the art may be used, but epoxy sealants may be especially advantageous for certain applications. In other applications curable silicone rubber formulations such as are available from Momentive (Waterford, N.Y.) may be used. In one or more embodiments illustrated by FIG. 1, fixative 30 hermetically seals the interior of probe shaft 18 from the environment of the exposed end of the probe flap.

The probe flap may be of any shape which can be induced to deflect in response to contact with a fluid flowing through the fluid conduit. As noted, probe flaps comprising rectangular shaped metal strips have been found especially suitable as they are sensitive to changes in fluid flow angle without exhibiting hysteresis to the flow angle and are manufactured relatively easily.

Sturdy, lightweight probe flaps may be prepared from, metals such as aluminum, stainless steel and titanium for example. Engineering polymers, both filled and unfilled, such as, PU (polyurethane), PVC (polyvinyl chloride), PEEK (polyether ether ketone), PAI (polyamide-imide) as exemplified by VICTREX HT and TORLON respectively, and PEI (polyether imide) as exemplified by ULTEM may also be used. Composite materials comprising organic polymers such as epoxy resins and glass or carbon fibers are suitable in a number of applications as well. In one or more embodiments, the probe flap comprises silicon. For example, the probe flap may be cut from a silicon wafer and etched at locations at which strain/stress sensitive elements are to be deployed in order to enhance sensor-probe flap compliance/response.

Materials suitable for use as materials of construction for the probe flap are in many instances also suitable for use as materials of construction for the probe body and probe shaft. Thus, in one or more embodiments, the probe flap, the probe body and the probe shaft are fashioned from stainless steel. In an alternate set of embodiments, the probe flap, the probe body and the probe shaft are fashioned from PEEK.

A host of manufacturing techniques may be advantageously applied to make various components of the flow angle probe provided by the present invention. For example, the probe flap, probe body and probe shaft may be produced by injection molding, microinjection molding, additive manufacturing and other known processing techniques. In some embodiments, the probe flap, probe body and probe shaft are comprised of an amagnetic, corrosion resistant steel alloy such as stainless steel of type 304. In some instances, the flow angle probe provided by the present invention is advantageously small in size and can be produced using micromachining, microassembly and other microfabrication techniques known to those of ordinary skill in the art.

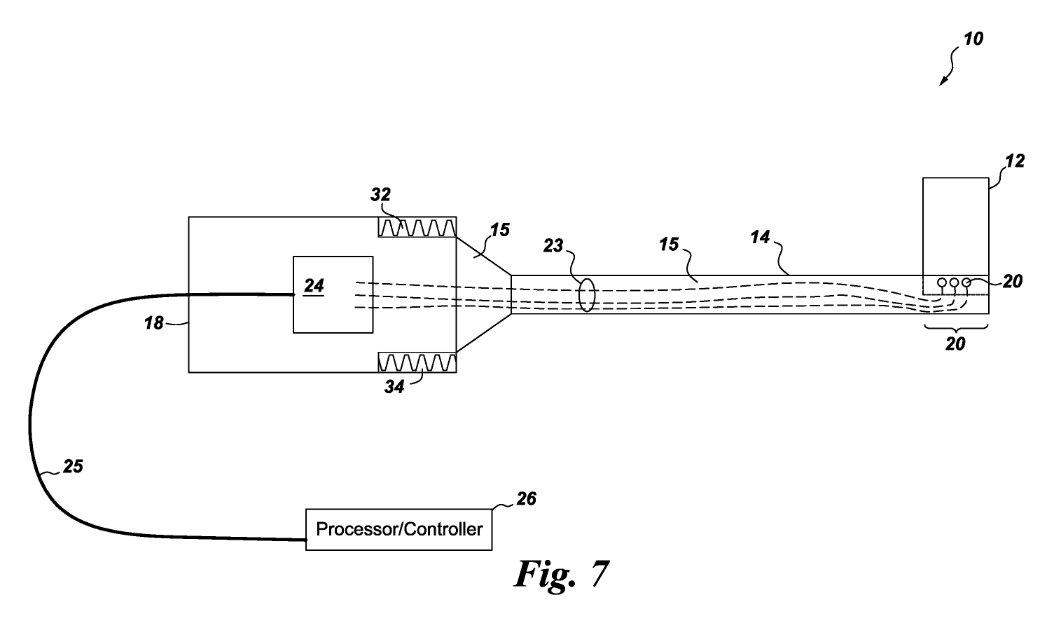

Returning now to the figures, FIG. 2 represents a flow angle probe 10 provided by the present invention in which the probe flap is rotated by rotation of the probe flap 12, the probe body 14 and probe shaft 18 in concert as indicated by the three arrows 40 indicating direction of rotation. Neither FIG. 2 or any other figure disclosed herein are meant to be to scale and showing the relative sizes of one probe component to another. However, FIG. 2 is intended to show the probe flap 12 as substantially enveloped by the probe body. By substantially enveloped it is meant that at least 50 percent of the length of the flap is disposed within the interior portion 15 of the probe body 14. In one embodiment, at least 75 percent of the length of the flap is disposed within the probe body. In yet another embodiment, at least 85 percent of the length of the flap is disposed within the probe body. Contrast this with FIG. 7 which illustrates, inter alia, a flow angle probe provided by the present invention in which the probe flap is disposed substantially outside of the probe body. By substantially outside it is meant that at least 50 percent of the length of the flap is disposed outside of the probe body. In one embodiment, at least 55 percent of the length of the flap is disposed outside of the probe body. In yet another embodiment, at least 75 percent of the length of the flap is disposed outside of the probe body. In yet still another embodiment, at least 85 percent of the length of the probe flap is disposed outside of the probe body.

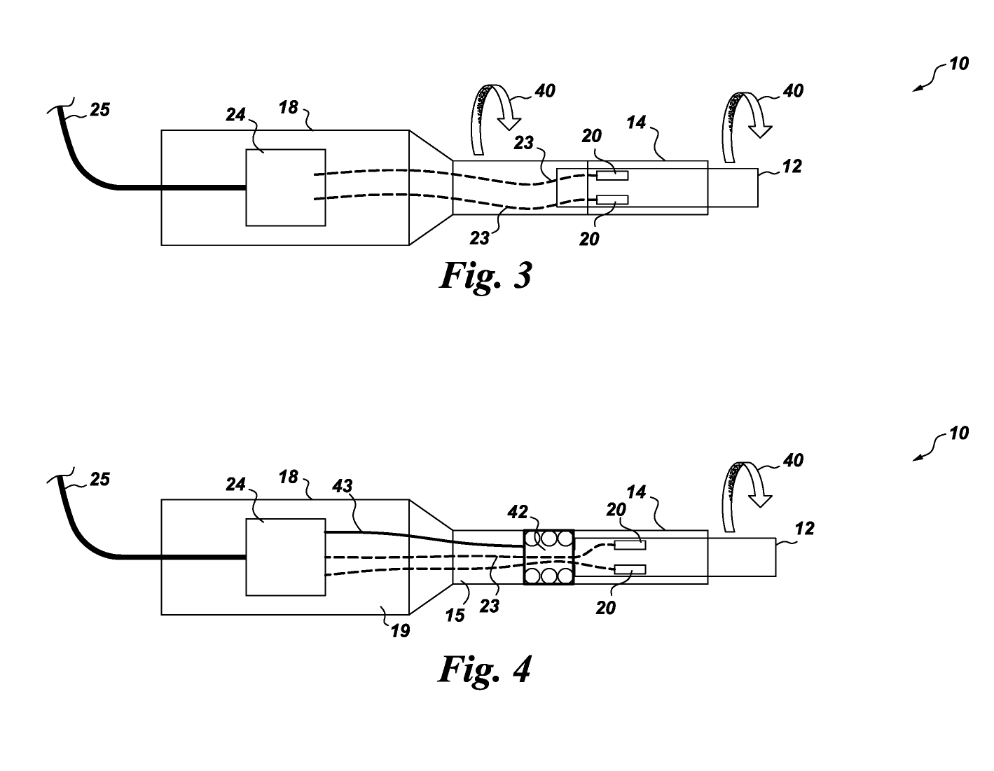

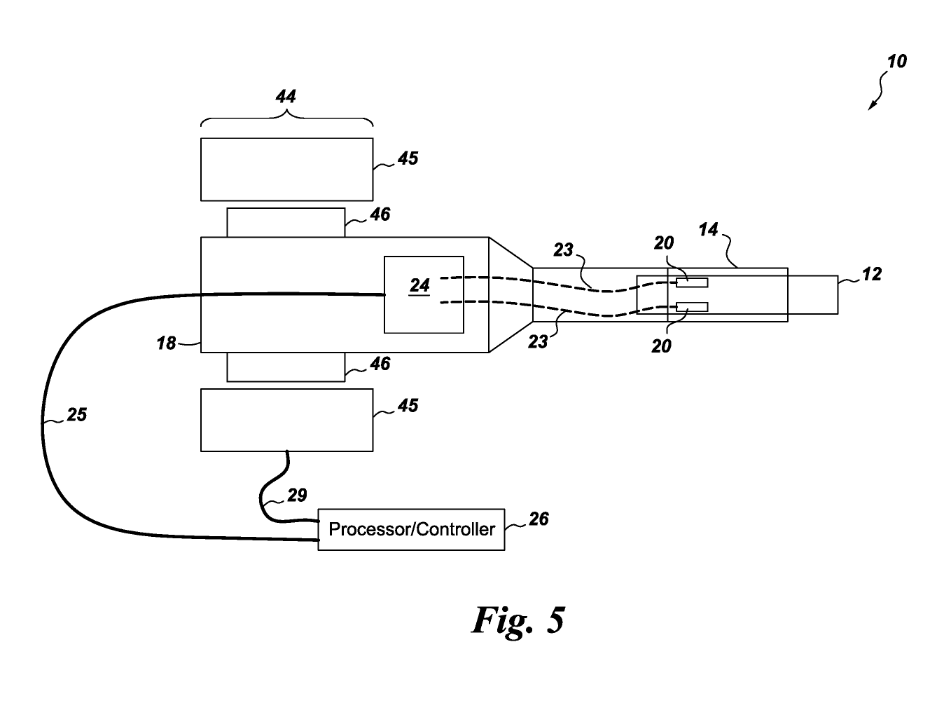

Referring to FIG. 3, the figure represents a flow angle probe 10 provided by the present invention in which in which the probe flap is rotated by rotation of the probe flap 12 in concert with the probe body 14 independent of fixed probe shaft 18, as indicated by the two arrows 40 indicating direction of rotation. In such embodiments, the probe body 14 may rotate relative to a fixed probe shaft 18, the probe shaft and probe body being mechanically coupled in a manner permitting independent rotation of the probe body relative to a stationary probe shaft. Such rotary couplings are known to those of ordinary skill in the art. Under such circumstances, a rotary driver 44 (See FIG. 5) attached to the outer surface of the probe body, as opposed to the probe shaft, may be used to rotate the probe body and probe flap relative to a stationary probe shaft.

Referring to FIG. 4, the figure represents a flow angle probe 10 provided by the present invention in which the probe flap 12 alone is rotary while the probe body 14 and the optional probe shaft 18 are stationary. The rotation of the probe flap 12 necessary to determine the fluid flow angle in the vicinity of the exposed portion of the probe flap is achieved by mounting the probe flap 12 on a lockable bearing 42 within probe body 14. On command of a probe controller (not shown in FIG. 4) communicating with the lockable bearing 42 via force signal transceiver 24 the bearing may be unlocked or locked via bearing control cable 43. When locked, a moving fluid in the fluid conduit contacting the exposed portion of the probe flap 12 exerts a force sensed by the force sensors 20. The force sensor data is received by force signal transceiver 24 via sensor link 23 and is transmitted to a processor/controller (not shown in FIG. 4) which records the data and sends a command via the force signal transceiver to unlock bearing 42 and allow the probe flap 12 to rotate under the influence of the flowing fluid into a position where the signal output of the force sensors 20 and the fluid flow angle at the exposed surface of probe flap are at a minimum. This position, encoded as a rotation of the bearing 42 from a reference position, is then transmitted back to the processor/controller and recorded. Because bearing 42 and probe flap 12 co-rotate and are physically connected to the force signal transceiver 24 via sensor links 23 to the force sensors 20, the flow angle probe may be advantageously equipped with sensor links 23 constituted by wires of sufficient length to sustain the mild torsion exerted by the unlocked bearing and probe flap as they rotate to a position of minimum force sensor signal output.

Referring to FIG. 5, the figure represents a flow angle probe 10 provided by the present invention. In the embodiment shown, the probe flap 12, force sensors 20, sensor links 23 to force signal transceiver 24, probe body 14, probe shaft 18 and communications link 25 are configured essentially as in FIG. 1. The figure illustrates as additional features the fact that communications link 25 communicates with a processor/controller 26 which receives force sensor data from force signal transceiver 24 indicating a deflection of probe flap 12 in response to contact with a flowing fluid. The processor/controller 26 is linked via control cable 29 to a rotary driver 44 which rotates probe shaft 18 causing probe body 14 and probe flap 12 to rotate in concert with probe shaft 18. The processor/controller 26 continues to receive force sensor data from the force signal transceiver 24 as the probe shaft is rotated. When the signal output of the force sensors is at a minimum, the angle of rotation relative to a reference position is recorded and this is taken as the flow angle of the flowing fluid in the vicinity of the probe flap 12. Those of ordinary skill in the art will understand that force signal transceiver 24 may amplify and modulate the signal output of the force sensors and transmit such amplified and/or modulated signals to the processor/controller. In the embodiment shown, rotary driver acts as an electric motor in which stator 45 drives a magnetically susceptible rotor 46 mechanically coupled to probe shaft 18.

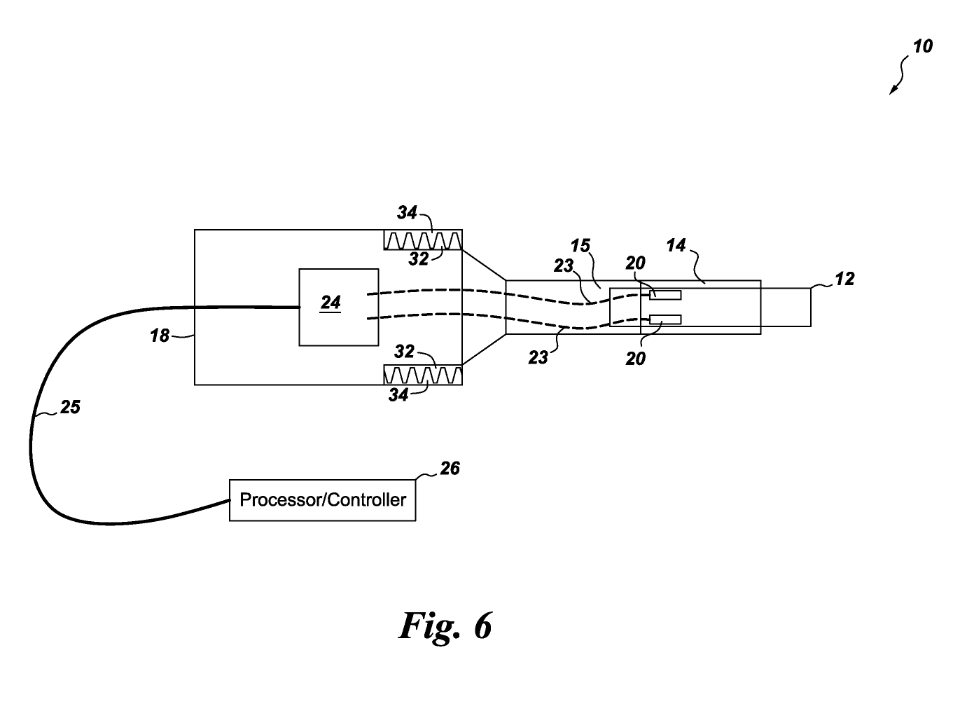

Referring to FIG. 6, the figure represents a flow angle probe 10 in which probe body 14 is mechanically coupled to probe shaft 18 via a set of probe body screw threads 32 disposed on an outer surface of probe body 14 and a set of complementary probe shaft screw threads 34 disposed on an inner surface of probe shaft 18.

Referring to FIG. 7, the figure represents a flow angle probe 10 in which the probe flap 12 is disposed substantially outside of the probe body. Force sensors 20 communicate force sensor data via sensor links 23 to the force signal transceiver 24 which may amplify and modulate the force sensor output and transmit the amplified and/or modulated force sensor output to a processor/controller 26.

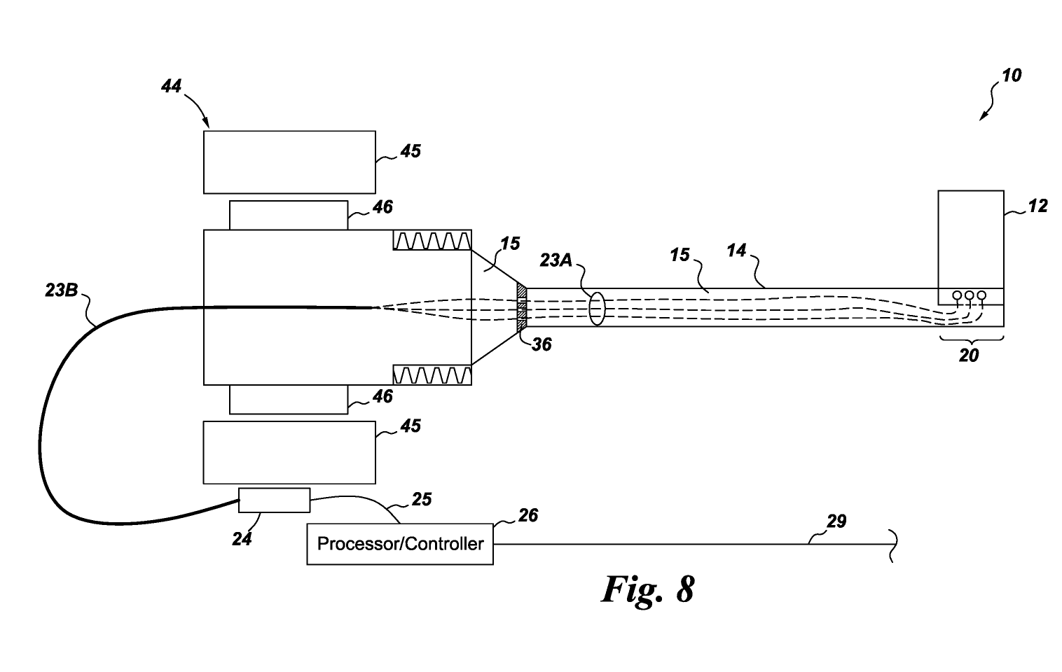

Referring to FIG. 8, the figure represents a flow angle probe 10 of the type illustrated in FIG. 7 wherein the probe flap 12 is disposed substantially outside of the probe body. Additional features shown include a hermetic seal 36 within the interior 15 of probe body 14 though which sensor links 23A pass. Sensor links 23A are consolidated into cable 23B which communicates with force signal transceiver 24. In the embodiment shown, force signal transceiver 24 is located outside of the probe shaft 18. Rotary driver 44 provides for the in concert rotation of probe shaft 18, probe body 14 and probe flap 12, and is controlled via control cable 29.

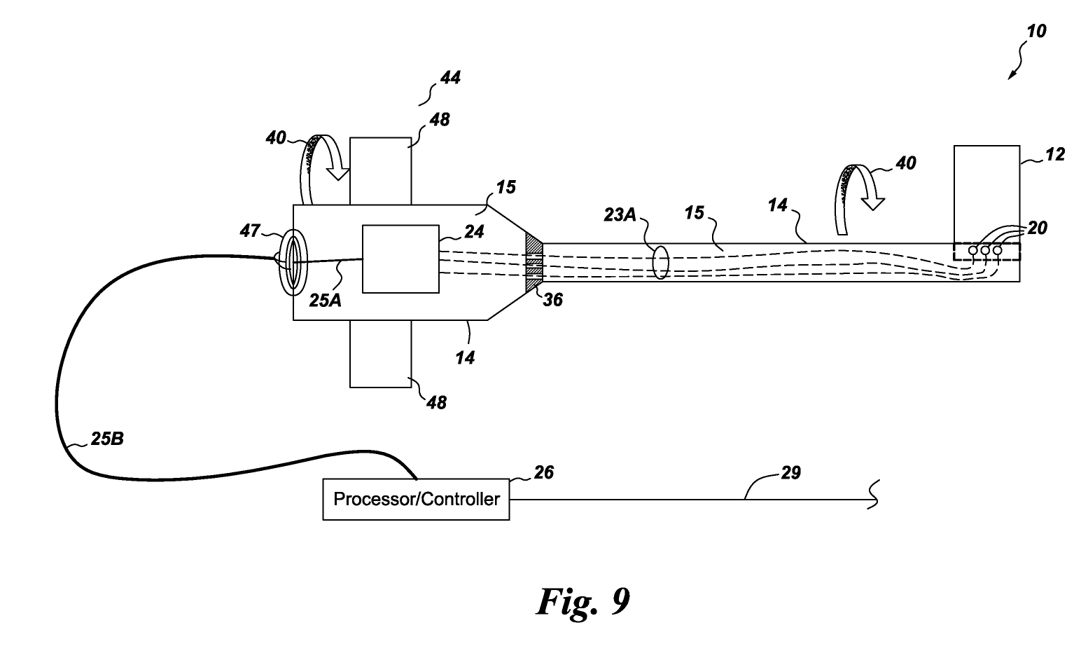

Referring to FIG. 9, the figure represents a flow angle probe 10 of the type featured in FIG. 7 and FIG. 8 wherein the probe flap 12 is disposed substantially outside of the probe body. An analog signal output of strain sensors 20 disposed upon the surface of probe flap 12 is received by force signal transceiver 24 via sensor links 23. A hermetic seal 36 within the interior 15 of probe body 14 and through which sensor links 23 pass, isolates the force signal transceiver 24 from the environment of the probe flap. The force signal transceiver comprising an analog to digital converter transmits digital signals via rotating communications link 25A to stationary communications link 25B and processor/controller 26 via rotary contact 47. In one or more embodiments, the rotary contacts 47 employ contactless slip rings to transmit both power and data between stationary and rotary components. Rotary driver 44 is controlled via control cable 29, and in the embodiment shown comprises a first toothed wheel 48 attached to the probe shaft 18. A second toothed wheel (not shown) intermeshes with the first toothed wheel and acts as the driving complement to the first toothed wheel. Such toothed wheel rotary drivers are known to those of ordinary skill in the art.

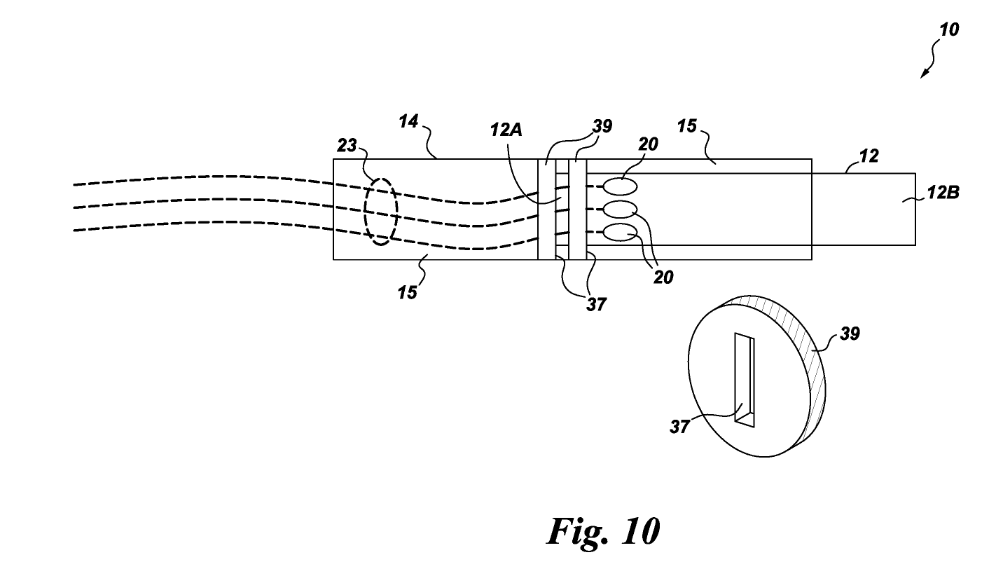

Referring to FIG. 10, the figure represents components of a flow angle probe 10 provided by the present invention. These components include a probe flap 12 disposed within an interior portion 15 of a probe body 14. A first end 12A of probe flap 12 is secured within the interior of the probe body by slotted structures 39 which define at least one slot 37 into which end 12A of probe flap 12 is inserted. The slotted structures are designed such that probe flap 12 may be reproducibly positioned within the probe body 14 during manufacturing operations. Thus, for a cylindrically shaped slotted structure 39 of dimensions such that it can be inserted and secured within the interior 15 of a cylindrical probe body, for example by a heat shrinking technique, the slot configured to receive end 12A of the probe flap 12 be cut with precision into a blank precursor cylinder such that when both the slotted structure and the probe flap are secured within the probe body, the surfaces of the probe flap occupy predetermined positions relative to the interior walls of the probe body. The precision cut slot may be created such that the position of the probe flap within probe body is highly symmetric with respect to the probe body interior walls. Alternatively, the precision cut slot may be created such that the position of the probe flap within probe body is asymmetric with respect to the probe body interior walls. In the embodiment shown, two slotted structures 39 are present. The slots 37 of the slotted structures may be sized to accommodate both a portion of the probe flap and sensor links 23 to force signal transceiver 24. In one or more embodiments, the slotted structures define grooves configured to accommodate sensor links 23 to force signal transceiver 24. In one such embodiment, the sensor links 23 are strain sensing fiber optic cables and the strain sensors 20 are Bragg gratings. In another set of embodiments, the sensor links 23 are electrically conductive wires and the sensors 20 are water resistant strain gauges. In one or more embodiments, the slotted structures define slots 37 which are sized appropriately to accommodate the probe flap 12, the sensor links 23 to the force signal transceiver 24 and a sufficient amount of a sealant such as a curable epoxy resin or curable silicone rubber to hermetically seal a portion of the interior 15 of the probe body 14 from the environment of the exposed end of the probe flap 12, end 12B. In the embodiment shown, end 12B extends outside of probe body 14 and this portion of probe flap is said to be configured to contact a moving fluid within a fluid conduit, because it will contact the moving fluid unimpeded by the walls of the probe body. In the embodiment shown, force sensors 20 are attached to the surface of the probe flap 12 at a point within the probe body interior 15 in contact with the fluid flowing in the fluid conduit.

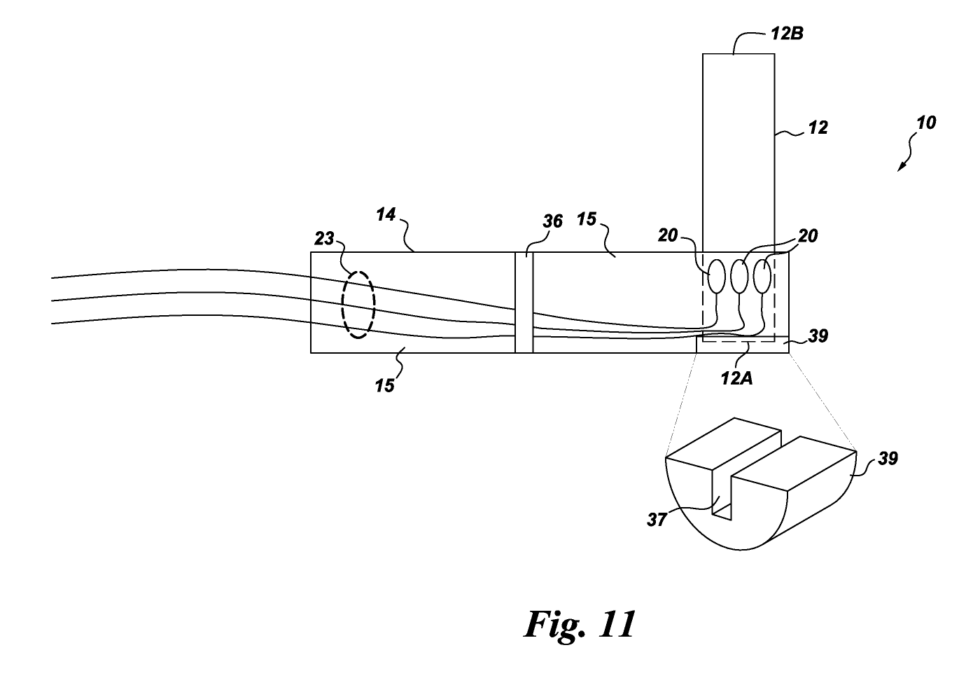

Referring to FIG. 11, the figure represents components of a flow angle probe 10 provided by the present invention and are intended to depict the probe flap 12 as being substantially outside of the probe body. In the embodiment shown, the probe body 15 defines a slot (not shown) through which probe flap may be inserted, and a slotted structure 39 to which the end 12A of the probe flap may be secured within the interior of the probe body. The slot defined in the probe body is sized appropriately to allow the probe flap a sufficient range of deflection within this slot to provide a useful dynamic range for the flow angle probe of which it is a part. Hermetic seal 36 divides the interior of the probe body and accommodates the passage of sensor links 23 to the force signal transceiver 24 (not shown).

Referring to FIG. 12, the figure illustrates a system 100 comprising a plurality of flow angle probes 10 provided by the present invention. Flow angle probes 10 are shown as disposed within transverse probe ports 70. In the embodiment shown, the system is a turbomachine, for example a compressor, comprising a plurality of flow angle probes 10 deployed within the fluid conduit 53 of the machine. The system comprises a motor (not shown) powering a rotor 50, impellers 54 affixed to the outer surface of the rotor, and at least one diffuser 56. A flow of fluid 51 entering the fluid conduit from the left encounters a first (leftmost) flow angle probe 10 which measures the flow angle in the vicinity of the probe flap 12. Fluid is compressed by the first impeller 54, and a second flow angle probe 10 measures the flow angle in the vicinity of the probe flap following this first compression stage. The fluid then encounters diffuser 56 and a third flow angle probe 10 which again measures the flow angle in the vicinity of the probe flap following this first diffuser stage. A second compression stage follows and the fluid is further compressed. A fourth flow angle probe measures the flow angle in the vicinity of the probe flap following this second compression stage. Flow angle data obtained along the fluid conduit flow channel 57 may be used to validate flow simulation studies and to validate, or refute, machine design assumptions. In one or more embodiments, the flow angle probe data is provided to a controller-processor 58 which uses the data in real time to operate the system more efficiently, for example by increasing or decreasing fluid swirl within the fluid conduit by, for example, adjusting the position of one or more guide vanes (not shown) within the fluid conduit, or by independently adjusting the speed of multiple shafts of a multi-spool fluid processing machine.

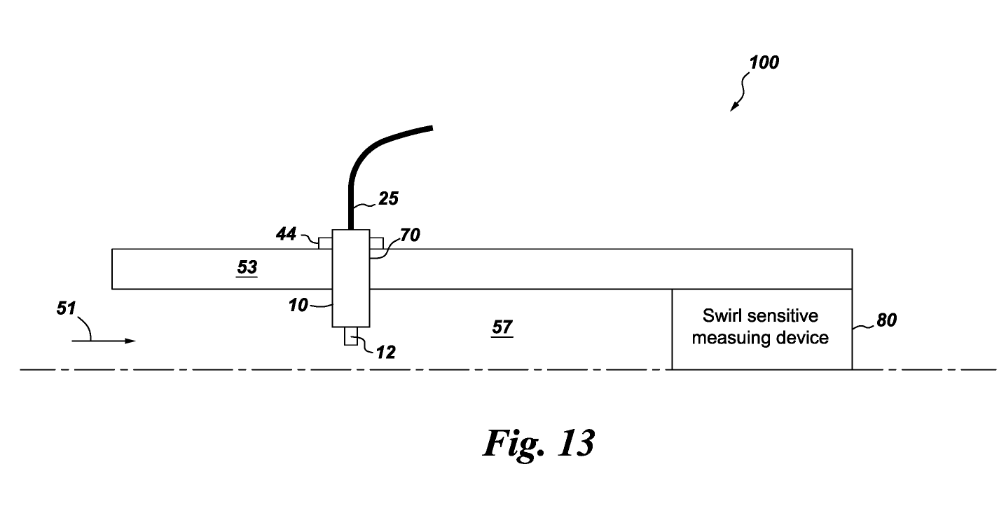

Referring to FIG. 13, the figure represents the use of a flow angle probe provided by the present invention in a flow assurance application. In the embodiment shown, flow angle probe 10 is deployed within the flow channel 57 of a fluid conduit 53 which is a pipeline. In one or more embodiments, flow angle probe 10 is deployed upstream of a swirl sensitive measuring device 80 as part of a flow assurance protocol. Flow angle probe 10 is configured to detect changes in swirl within the pipeline that may relate to changes in pipeline structural integrity. A communications link 25 to a controller may be configured to alert a remote supervisory facility of a potential or actual problem.

### Methods and Results

### Method 1: Flow Angle Probe

A stainless steel probe body 52 millimeters in length was precision machined from a solid stainless steel cylinder of approximately the same length. The probe body was open at one end and, with the exception of three holes drilled to accommodate sensor wiring, was closed at the other end. The probe body was machined such that at the open end it had an outer diameter of 4 millimeters. The probe body exterior gradually tapered over the first 27 mm of its length from an outer diameter of 4 millimeters at the open end to an outer diameter of 5 mm. Over the next 10 mm the probe body exterior tapered more markedly from the 5 mm outer diameter to a 10 mm outer diameter which was held constant at 10 mm for the next 3 mm of the length of the probe body. A set of male screw threads occupied the remaining 12 mm of the probe body at its closed end and had an approximate diameter of 9.5 mm.

The probe body defined a cylindrical interior volume having a constant diameter of 3.5 mm along a 20 mm length of the probe body measured from the open end. Thereafter, the diameter of the cylindrical interior volume of the probe body was reduced to approximately 2 mm and was sufficient in size to accommodate three wires destined to link the strain sensors to a strain gauge signal amplifier comprising a TEDS chip.

The probe flap was a stainless steel rectangular plate having a thickness of approximately 0.2 mm, a width of approximately 3 mm and a length of approximately 26 mm. The surfaces of the probe flap were cleaned and dried and strain gauges (HBM, model #1-LY11-0.6/120) were attached using a curable adhesive (HBM Z70) on opposite sides of the probe flap at a distance of approximately 13 mm from the end of the probe flap destined to contact a moving fluid in the completed flow angle probe. Each strain gauge comprised a first excitation voltage lead (hot lead), and each comprised a neutral return lead. The three wires destined to connect the strain gauges with the signal amplifier were inserted through the three holes in the closed end of the probe body, through the probe body interior, and out through the probe body open end. The hot leads of the strain gauges were soldered to a single excitation voltage wire and each of the neutral leads were soldered to dedicated neutral return wires. All leads wires were substantially covered in closely fitting, polyurethane dielectric sleeves.

The probe flap was then drawn into the probe body interior using the three wires exiting the probe body interior from the closed end of the probe body. The closed end of the probe body was then hermetically sealed with Terostat plastic sealant. The probe body was then clamped vertically with the open end upwards. A 6 mm portion of the probe flap extended outside of the probe body at its open end. The probe flap centered with respect to the interior walls of the probe body and secured in such centered position. Sufficient liquid epoxy resin (MGS L285+H286) was then dispensed into the probe interior such that the lower portion of the probe body interior and the lower portion of the probe flap were in contact with the resin. The strain gauges were not in contact with the epoxy. The resin was then cured thereby securing the position of the probe flap.

The three wires exiting the closed end of the probe body were then connected to a shielded cable extending through the interior of a rigid, hollow probe shaft. The probe shaft was a stainless steel tube approximately 600 mm in length and comprising a set of female screw threads complementary to the screw threads of the probe body.

### Method 2: Flow Angle Probe Validation Testing

Flow angle tests were carried out on a 15 meter multiphase fluid vertical test rig at the Institute for Energy Technology (IFE) in Kjeller, Norway. The experimental flow angle probe constructed as described in Method 1 was used in the tests described herein.

The probe was inserted through a traverse probe port of the fluid conduit of the test rig about 12 meters above the rig's fluid pump. The fluid conduit was approximately 100 millimeters in diameter. The flow angle probe was positioned orthogonal to the direction of flow within the test rig fluid conduit and such that the probe flap was astride the center axis of the fluid conduit in order to minimize boundary effects at the fluid conduit wall surface. The test rig was equipped with a downstream gas-liquid separator and recycle loops to channel gas and liquid test fluids back to a fluid mixer upstream of the straight 15 meter long vertical test section. The water loop was driven by a pump and the gas loop was driven by a compressor. The steel probe shaft attached the probe body was supported by a motor-driven, rotary table which was rotated to angles between +90 degrees and −90 degrees relative to a reference point in which the probe flap was aligned with flow through the fluid conduit. In these tests, rotation of the steel shaft caused the probe flap to rotate to the same degree as the shaft since the probe flap was not configured to rotate independently of the probe shaft and probe body. As the probe flap co-rotated with the probe shaft and probe body through a series of fixed angles between +90 and −90 degrees around the reference point, the output signals of the strain sensors were monitored and these output signals together with the angular position of the probe shaft were transmitted to a data processor. In operation, the rotation of the probe shaft and strain sensor data collection were automated using one or more data processing and controller systems. At each fixed angle selected, strain sensor output data was sampled at 4800 Hertz over a ten second collection time and the resultant data set was averaged to produce an average value. Flow angle probe performance was robust under a wide variety of conditions including conditions of 0% (water only) and 100% (air only) gas-volume fractions, and gas-liquid regimes having gas-volume fractions intermediate 0% and 100%.

The foregoing examples are merely illustrative, serving to illustrate only some of the features of the invention. The appended claims are intended to illustrate the invention as broadly as it has been conceived and the examples herein presented are illustrative of selected embodiments from a manifold of all possible embodiments. Accordingly, it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. A flow angle probe comprising:
(a) a probe flap configured to contact a moving fluid within a fluid conduit;
(b) a probe body mechanically coupled to the probe flap;
(c) a force sensor disposed within the probe body and operationally coupled to the probe flap; and optionally
(d) a probe shaft coupled to the probe body;
wherein a deflection of the probe flap caused by contact with the moving fluid produces a corresponding sensed force in the force sensor; and
wherein the sensed force produced in the force sensor may be minimized by rotation of the probe flap to a position in which deflection of the probe flap by the moving fluid is minimized.

2. The flow angle probe according to claim 1, wherein the probe flap is substantially enveloped by the probe body.

3. The flow angle probe according to claim 1, wherein the force sensor is a fiber optic sensor.

4. The flow angle probe according to claim 1, wherein the force sensor is a magnetic sensor.

5. The flow angle probe according to claim 1, wherein the force sensor is a strain sensor (Classical strain sensor based on change in electrical resistance).

6. The flow angle probe according to claim 1, comprising a probe shaft.

7. The flow angle probe according to claim 6, wherein the rotation of the probe flap to a position in which deformation of the probe flap is minimized is effected by rotation of the probe shaft, the probe body and the probe flap in concert.

8. The flow angle probe according to claim 1, wherein the rotation of the probe flap to a position in which deformation of the probe flap is minimized is effected by rotation of the probe body and the probe flap in concert.

9. The flow angle probe according to claim 1, wherein the rotation of the probe flap to a position in which deformation of the probe flap is minimized is effected by independent rotation of the probe flap.

10. A system comprising:
(a) a fluid conduit configured to accommodate fluid flow;
(b) a flow angle probe comprising:
(i) a probe flap configured to contact a moving fluid within a fluid conduit;
(ii) a probe body mechanically coupled to the probe flap;
(iii) a force sensor disposed within the probe body and operationally coupled to the probe flap; and optionally
(iv) a probe shaft coupled to the probe body;
(d) a rotary driver configured to cause one or more of the probe body and the probe shaft to rotate; and
(e) a controller configured to control the rotary driver;
wherein a deflection of the probe flap caused by contact with the moving fluid produces a corresponding sensed force in the force sensor; and
wherein the sensed force produced in the force sensor may be minimized by rotation of the probe flap to a position in which deflection of the probe flap by the moving fluid is minimized.

11. The system according to claim 10, wherein probe flap is substantially enveloped by the probe body.

12. The system according to claim 10, wherein the system does not comprise a probe shaft.

13. The system according to claim 10, wherein the force sensor is selected from the group consisting of fiber optic sensors, magnetic sensors, and electrical resistance sensors.

14. The system according to claim 10, wherein the rotation of the probe flap to a position in which deflection of the probe flap is minimized is effected by rotation of the probe shaft, the probe body and the probe flap in concert.

15. A flow angle probe comprising:
(a) a probe flap configured to contact a moving fluid within a fluid conduit;
(b) a probe body mechanically coupled to the probe flap;
(c) at least one strain sensor disposed within the probe body and operationally coupled to the probe flap; and
(d) a probe shaft coupled to the probe body;
wherein a deflection of the probe flap caused by contact with the moving fluid produces a corresponding strain in the strain sensor; and
wherein the strain produced in the strain sensor may be minimized by rotation of the probe flap to a position in which deflection of the probe flap by the moving fluid is minimized.

16. The flow angle probe according to claim 15, wherein the probe flap is disposed substantially outside of the probe body.

17. The flow angle probe according to claim 15, wherein the probe flap is disposed substantially within of the probe body.

18. The flow angle probe according to claim 15, wherein a signal produced by the strain sensor is received and modulated by a signal processor disposed within the probe shaft.

19. The flow angle probe according to claim 15, wherein a signal produced by the strain sensor is received and modulated by a signal processor disposed outside of the probe shaft.

20. The flow angle probe according to claim 15, wherein the strain sensor is an electrical resistance strain sensor.

21. The flow angle probe according to claim 15, wherein the strain sensor is a fiber optic strain sensor.
